(19) United States
(12) Patent Application Publication
(10) Pub. No.: US 2025/0369468 A1
(43) Pub. Date: Dec. 4, 2025

(54) MLI FASTENING SYSTEM

(71) Applicant: WEB INDUSTRIES, INC., Marlborough, MA (US)

(72) Inventor: Thomas P. Miller, Oxnard, CA (US)

(73) Assignee: WEB INDUSTRIES, INC., Marlborough, MA (US)

(21) Appl. No.: 19/191,150

(22) Filed: Apr. 28, 2025

Related U.S. Application Data
(60) Provisional application No. 63/639,942, filed on Apr. 29, 2024.

(51) Int. Cl. F16B 5/06; B64G 1/58

(52) U.S. Cl. CPC F16B 5/065; B64G 1/58; F16B 2200/93

(57) ABSTRACT

An MLI panel and method of attaching the same to a space body wherein the MLI panels are attached by way of a plurality of electrically conductive interference fit or snap-fit locking elements.

### RELATED APPLICATIONS

The present application claims the benefit of prior U.S. Provisional Patent Application No. 63/639,942, filed Apr. 29, 2024, entitled “Improved MLI Fastenting System,” the contents of which are hereby incorporated herein by reference in their entirety.

### FIELD OF THE INVENTION

The present teaching is directed to multi-layer insulation, particularly multi-layer insulation panels, their manufacture and use. In particular the present teaching is directed to multi-layer insulation panels which integrate an improved fastening system, specifically a snap-fit fastening system, for fastening the multi-layer insulation panels to a space body to be insulated, most especially for space craft and satellites.

### BACKGROUND

Space bodies such as satellites and spacecraft are subject to extreme temperatures and temperature variations as well as continual bombardment by electrons resulting in the buildup of electric charges. In order to address the former, multi-layered insulation is employed to blanket the space body from such extreme temperatures and temperature fluctuations. Here, insulation on those portions of the space body exposed to the sun will protect those surfaces from the heating effect of the sun. Insulation on those areas not exposed to the sun, protect the space body from heat loss due to radiation. While extremely important to the proper and long-term functioning of the space body, these insulating layers are also prone to generating and/or the buildup of electric charges due to their continual bombardment with electrons: an effect which is markedly increased by solar flares and electromagnetic waves crossing through space. Such electric buildups can lead to damage to and/or interference with the performance of the underlying craft and/or its electronics and communications systems, particularly through arching.

Multi-layer insulation (“MLI”) for space applications is well known and widely available. Typically, an MLI blanket is comprised of multiple layers of a thin material with low IR emissivity, preferably lightweight reflective films, and a durable outer layer. Preferably, the MLIs comprise multiple layers of metal coated polymer films, metal foils and/or combinations thereof: the latter most preferably being metal coated polymer films and an outermost layer of a metal foil. Most preferably, MLIs, especially the inner layers thereof, are comprised of a polyimide and/or polyester films having vapor deposited aluminum (high purity aluminum, >95%, preferably, >99%, most preferably 99.99%) on one or both sides. These films may be further coated with ITO, SiO₂ or both, particularly the exposed exterior layer, especially to add durability. On certain applications, the aluminum may be substituted with silver and/or germanium. MLI structures typically comprise from 5 to 30 layers, more commonly 10 to 20 layers: the layers being spaced from one another to avoid thermally conductive contact. Such spacing is typically achieved by i) the use of embossing of the low IR emissivity material layers or ii) the placement of thin polymer netting, spunbonded or woven material, which acts as thermal insulation, or other spacers, between the layers of low IR emissivity material. Additionally, the low IR emissivity material layers may be perforated to allow the MLI to vent trapped gas once arriving on-orbit, although this can also be achieved via edge venting. Exemplary MLIs are disclosed in, for example, Hasegawa et. al. (US 2003/0082332 A1), EP 2530366 A1 and FR 2976044 A1, the contents of which are hereby incorporated herein by reference.

The MLI structures are formed and held together by clamps; fasteners, such as rivets with a counter-hold, plug-in pin assemblies, and screw/nut assemblies; threads/fibers sewn through the layers; interconnected spacer elements, etc. as well as combinations thereof. The fastener elements and interconnected spacer elements may be made of plastic or metal or metal coated plastic. Exemplary threads include graphite, metal or metalized organic fibers. The presence of metal on some or all of the fasteners and threads allows for conductivity of the electrostatic charges. On the other hand, typically the number of metal or metal coated elements is minimized so as to avoid thermal conductivity between the layers of the insulating material. The MLIs are typically affixed to the space bodies by use of adhesives, hook and loop assemblies (Velcro) and combinations thereof. The adhesives and hook and loop assemblies may be electrically conductive and/or conductive leads may be used which connect the MLI to the space body directly to provide an electrically conductive pathway, i.e., a ground.

Despite all the advances made in MLI and MLI fastening, there continues to be ongoing development, need and search for simpler and more effective, from a cost, implementation, and/or performance perspective, fastening means and systems for affixing MLI to a space body.

### SUMMARY

According to a first aspect of the present teaching there is provided an MLI panel for attachment to a space body, the MLI panel comprising a plurality of stacked insulation layers, said MLI panel having an exterior surface layer which, in use, faces away from the space body to which it is attached, said exterior surface layer having an exterior surface facing away from the space body, and a base layer which, in use, faces the space body to which it is attached, and a plurality of spaced fastening elements, preferably pin elements, most preferably electrically conductive pin elements, generally perpendicular to and extending through the stacked insulation layers and protruding from the base layer, each fastening element having a shaft, a head at one end of the shaft which engages or sits, directly or indirectly, upon the exterior surface of the exterior surface layer, and a shaft end at the other end which i) protrudes from the base layer, the shaft end having a length that is such that when the shaft end engages a space body the MLI panel is spaced from the space body and ii) has a shape or configuration designed/adapted to establish an interference fit or snap fit with the space body or a component or element thereof or attached thereto.

According to a second aspect of the present teaching there is provided an MLI panel for attachment to a space body, the MLI panel comprising a plurality of stacked insulation layers, said MLI panel having an exterior surface layer which, in use, faces away from the space body to which it is attached, and a plurality of spaced fastening systems, each fastening system comprising (A) a pin-type element, preferably an electrically conductive pin element and (B) a removeable seat or counter-hold element: the pin-type element generally perpendicular to and extending through the stacked insulation layers and protruding from the base layer, and having a shaft, a head at one end of the shaft which engages or sits, directly or indirectly, upon the exterior surface of the exterior surface layer, and a shaft end at the other end, the shaft end i) protruding from the base layer and having a length that is such that when the shaft end engages a space body the MLI panel is spaced from the space body, and ii) has a shape or configuration designed/adapted to establish an interference fit or snap fit with (B) the removeable seat or counter-hold element, the removeable seat or counter-hold element having an opening or barrel therein or stud or stud-like element thereon capable of and designed/adapted to accept the shaft end of the pin-type element in an interference fit and/or a snap fit arrangement. Optionally, the removeable seat or counter-hold element (B) may comprise a base element that is capable of being affixed to or integrated into the surface of a space body for attaching the MLI to the space body.

According to a third aspect of the present teaching there is provided a method for producing an MLI panel comprising a plurality of stacked insulation layers, the stacked insulation layers comprising a) an exterior surface layer which, in use, faces away from the space body to which the MLI panel is to be attached, said exterior surface layer having an exterior surface facing away from the remainder of the stacked insulation layers, b) a base layer which, in use, faces the space body to which it is to be attached, and c) a plurality of insulation layers intermediate the two, said stack of insulation layers being held together by a plurality of spaced fastening elements, preferably pin elements, most preferably electrically conductive pin elements, generally perpendicular to and extending through the stacked insulation layers and protruding from the base layer, each fastening element having an elongated shaft whose length is longer than the height of the stacked insulation layers, a head at one end of the shaft and a shaft end at the other end which method comprises i) creating the stack of insulation layers, each layer thereof having a plurality of spaced holes, slits and/or star shaped perforations, each aligned over the spaced holes, slits and/or star shaped perforations of the other layers, ii) inserting the fastening elements into the spaced holes, slits and/or star shaped perforations of the exterior surface layer and iii) continuing to press the fastening elements into the spaced holes, slits and/or star shaped perforations until the head of the fastening elements contacts, directly or indirectly, the exterior surface of the exterior surface layer and the shaft end protrudes from the base layer, the shaft ends including or after insertion being modified to have a configuration or design adapted to establish an interference fit or snap fit with the space body or a component or element thereof or attached thereto. In those instances where the shaft end is designed/adapted to engage the space body to which the MLI panel is to be affixed, the method may, optionally, though preferably, further comprise affixing a temporary seat or counter-hold element to the shaft ends each temporary seat or counter-hold element having an opening or barrel therein capable of and designed/adapted to accept the shaft ends in an interference fit and/or snap fit relationship to prevent the insulating layers from being dislodged from the stack and/or the fastening elements from backing out of the stack. In this instance, it is also contemplated that the temporary seat or counter-hold element may be designed/adapted to be permanently affixed to/integrated into the space body, whereby in use, the temporary seat or counter-hold element is removed from the MLI panel and affixed to the space body following which the shaft ends of the MLI are once again engaged with the seat or counter-hold elements to secure the MLI to the space body. In the case of those MLI panels wherein the fastening element is a female fastening element designed/adapted to engage a male element on the space body, the method further comprises permanently affixing the female element to the shaft end. To ensure good electrical contact between the fastening elements and the insulation layers, the upper (i.e., outward facing) surface of each insulation layer is or has applied thereto a conductive material, most preferably, a vapor deposited conductive metal.

According to a fourth aspect of the present teaching there is provided a method for affixing an MLI panel comprising a plurality of stacked insulation layers to a space body, said MLI panel having an exterior surface layer which, in use, faces away from the space body to which it is attached, said exterior surface layer having an exterior surface facing away from the space body, and a base layer which, in use, faces the space body to which it is attached, and a plurality of spaced fastening elements, preferably pin elements, most preferably electrically conductive pin elements, generally perpendicular to and extending through the stacked insulation layers and protruding from the base layer, each fastening element having a shaft, a head at one end of the shaft which engages or sits, directly or indirectly, upon the exterior surface of the exterior surface layer, and a shaft end at the other end which i) protrudes from the base layer, the shaft end having a length that is such that when the shaft end engages a space body the MLI panel is spaced from the space body and ii) has a shape or configuration designed/adapted to establish an interference fit or snap fit with the space body or a component or element thereof or attached thereto, said method comprising I) overlaying the MLI panel over the space body and aligning the shaft ends with a corresponding plurality of seat or counter-hold elements affixed to and/or integrated into the space body and spaced from one another so as to match the spacing of the fastening elements of the MLI panel, the seat or counter-hold elements having an opening or barrel therein or stud or stud-like element thereon capable of and designed/adapted to accept the shaft ends in an interference fit and/or snap fit relationship, II) mating the MLI panel with the space body whereby the shaft ends engage a corresponding seat or counter-hold element and III) forcing the shaft ends into/onto the seat or counter-hold elements to create an interference fit or snap fit hold of the MLI panel on the space body.

Finally, according to a fifth aspect of the present teaching there is provided a space body having one or more MLI panels comprising a plurality of stacked insulation layers fastened thereto by way of an interference fit and/snap fit fastening system, wherein said one or more MLI panels has an exterior surface facing away from the space body, and a base layer facing the space body, a plurality of spaced fastening elements, preferably pin elements, most especially, electrically conductive pin elements, generally perpendicular to and extending through the stacked insulation layers and protruding from the base layer, each fastening element having a shaft, a head at one end of the shaft which engages or sits, directly or indirectly, upon the exterior surface of the exterior surface layer, and a shaft end at the other end which i) protrudes from the base layer and has a length such that the MLI panel is spaced from the space body, and ii) establishes an interference fit and/or snap fit with the space body.

In each of the foregoing embodiments or aspects of the present teaching, it is to be appreciated that the seat or counter-hold affixed to or integrated into the space body are electrically conductive whereby when the shaft ends engage the seat or counter-hold elements, an electrical pathway is established allowing electric charge to flow from the MLI to the space body, thereby grounding the MLI panel. Additionally, while it is preferred that the shaft and head of the fastening element, specifically the pin or pin-type element. are inserted into the stack of the insulation layers as a single element with the shaft end being initially inserted through the exterior surface and passing through the stack and protruding beyond the base layer, it is also contemplated that a two-part pin may be used whereby the shaft is initially inserted through the base layer and through the stack of insulation layers and the head affixed thereto as it protrudes from the exterior surface, with the shaft end remaining exposed and protruding from the base layer.

### BRIEF DESCRIPTION OF THE FIGURES

FIG. 1 is a side elevated perspective view of a cut out section of an MLI panel-space body assembly.

FIG. 2 is an expanded view of the portion A of the assembly of FIG. 1.

FIG. 3A a top-down, cross-sectional view of the of FIG. 2 taken along line 1-1.

FIG. 3B is a side view of the seat or counter-hold element of FIG. 2 with the upper, forward quadrant removed.

FIG. 4 is an alternative embodiment of the expanded view of portion A of the assembly of FIG. 1.

FIGS. 5A and 5B are top-down, cross-sectional views of the seat or counter-hold element of FIG. 4 taken along lines 2-2 and 3-3, respectively.

FIG. 5C is a side view of the seat or counter-hold element of FIG. 4 with the upper, forward quadrant removed.

FIG. 6A is a top-down view of a sheet of insulation with holes punched therein for accepting a pin element.

FIG. 6B is a top-down view of a sheet of insulation with star punches therein for accepting a pin element.

FIG. 7 depicts a pin element passing through a star punch of FIG. 6B.

FIG. 8 is an enlarged view of a cross-section of a pin interconnection through an MLI panel.

FIG. 9 is an enlarged view of a cross-section of an alternative embodiment of a pin interconnection through an MLI panel.

FIGS. 10A through E are cross-sectional views of various shapes/-configurations for the pin shaft ends that connects with the seat or counter-hold element on a space body.

FIG. 11 is a cross-section of one embodiment of a pin element.

FIG. 12 is a cross-section of a second embodiment of a pin element.

FIG. 13 is an enlarged cross-sectional view of a hole in an MLI layer.

FIG. 14 is an enlarged cross-sectional view of a hole in an alternate embodiment of an MLI layer.

FIG. 15 is an enlarged cross-sectional view of a star-punch in an MLI layer.

FIG. 16 is an enlarged cross-section view of a star-punch in an alternate embodiment of an MLI layer.

FIG. 17 is an elevated view of a portion of an MLI and a space body depicting the attachment of the former to the latter.

FIG. 18 is a partially exposed view of the female fastener element employed in the MLI of FIG. 17.

FIG. 19 is a partially exposed view of the male fastener element employed on the space body of FIG. 17.

### DETAILED DESCRIPTION

As used herein and the claims the term “pin” and “pin-type element” refers to a fastening element having an elongated body, a shaft, whose cross-section may be circular, a cross, a square, a rectangle or like shape; a head at one end of the elongated body which has a cross-section that is different in shape and/or has larger dimensions than the cross-section of the shaft; and a shaft end, the shaft end having a short body portion and an end, the end being a flat surface corresponding to a cross-section of the shaft, e.g., a ring when the shaft is hollow, a rounded or half-moon surface, a cone or a like three dimensional shape or configuration whose cross-section diminishes in surface area as one approaches the absolute end point and the length of the short body portion corresponding, in part, to the distance by which the MLI is to be spaced from the space body when attached.

As used herein and the claims reference to an “MLI” or “MLI panel” is to be understood as encompassing panels of any size, including small to large segments, panels, sheets or strips with the size, shape and rigidity thereof being a matter of the nature of the space body, or portion or element thereof, to be protected, e.g., satellite, space probe, space craft, space station, space lab, launch vehicle, etc.; the positioning and purpose of the MLI on the space body; the shape of the surface of the space body to be protected; etc.: all as well within the knowledge and skill of a person of the art. In following, while some MLIs may be rigid or somewhat rigid, most tend to be pliable and are commonly referred to as MLI blankets: all of which are contemplated herein by the term panel.

The present teaching is directed to a simpler, more cost effective system for fastening MLI panels, sheets and strips to a space body, especially for conductively fastening such panels, sheet and strips to a space body. Specifically, according to a first aspect of the present teaching there is provided an MLI panel for attachment to a space body, the MLI panel comprising a plurality of stacked insulation layers, said MLI panel having an exterior surface layer which, in use, faces away from the space body to which it is attached, said exterior surface layer having an exterior surface facing away from the space body, and a base layer which, in use, faces the space body to which it is attached, and a plurality of spaced fastening elements, preferably pin elements, most preferably electrically conductive pin elements, generally perpendicular to and extending through the stacked insulation layers and protruding from the base layer, each fastening element having a shaft, a head at one end of the shaft which engages or sits, directly or indirectly. upon the exterior surface of the exterior surface layer, and a shaft end at the other end which i) protrudes from the base layer, the shaft end having a length that is such that when the shaft end engages a space body the MLI panel is spaced from the space body and ii) has a shape or configuration designed/adapted to establish an interference fit or snap fit with the space body or a component or element thereof or attached thereto.

According to a second aspect of the present teaching there is provided an MLI panel for attachment to a space body, the MILI panel comprising a plurality of stacked insulation layers, said MLI panel having an exterior surface layer which, in use, faces away from the space body to which it is attached, and a plurality of spaced fastening systems, each fastening system comprising (A) a pin-type element, preferably an electrically conductive pin element and (B) a removeable seat or counter-hold element: the pin-type element generally perpendicular to and extending through the stacked insulation layers and protruding from the base layer, and having a shaft, a head at one end of the shaft which engages or sits, directly or indirectly, upon the exterior surface of the exterior surface layer, and a shaft end at the other end, the shaft end i) protruding from the base layer and having a length that is such that when the shaft end engages a space body the MLI panel is spaced from the space body, and ii) has a shape or configuration designed/adapted to establish an interference fit or snap fit with (B) the removeable seat or counter-hold element, the removeable seat or counter-hold element having an opening or barrel therein or stud or stud-like element thereon capable of and designed/adapted to accept the shaft end of the pin-type element in an interference fit and/or a snap fit arrangement. Optionally, the removeable seat or counter-hold element may comprise a base element that is capable of being affixed to or integrated into the surface of a space body for attaching the MLI to the space body.

According to a third aspect of the present teaching there is provided a method for producing an MLI panel comprising a plurality of stacked insulation layers, the stacked insulation layers comprising a) an exterior surface layer which, in use, faces away from the space body to which the MLI panel is to be attached, said exterior surface layer having an exterior surface facing away from the remainder of the stacked insulation layers, b) a base layer which, in use, faces the space body to which it is to be attached, and c) a plurality of insulation layers intermediate the two, said stack of insulation layers being held together by a plurality of spaced fastening elements, preferably pin elements, most preferably electrically conductive pin elements, generally perpendicular to and extending through the stacked insulation layers and protruding from the base layer, each fastening element having an elongated shaft whose length is longer than the height of the stacked insulation layers, a head at one end of the shaft and a shaft end at the other end which method comprises i) creating the stack of insulation layers, each layer thereof having a plurality of spaced holes, slits and/or star shaped perforations, each aligned over the spaced holes, slits and/or star shaped perforations of the other layers, ii) inserting the fastening elements into the spaced holes, slits and/or star shaped perforations of the exterior surface layer and iii) continuing to press the fastening elements into the spaced holes, slits and/or star shaped perforations until the head of the fastening elements contacts, directly or indirectly, the exterior surface of the exterior surface layer and the shaft end protrudes from the base layer: said shaft ends including or after insertion being modified to have a configuration or design adapted to establish an interference fit or snap fit with the space body or a component or element thereof or attached thereto. In those instances where the shaft end is designed/adapted to engage the space body to which the MLI panel is to be affixed, the method may, optionally, though preferably, further comprise affixing a temporary seat or counter-hold element to the shaft ends each temporary seat or counter-hold element having an opening or barrel therein or stud or stud-like element thereon capable of and designed/adapted to accept the shaft ends in an interference fit and/or snap fit relationship to prevent the insulating layers from being dislodged from the stack and/or the fastening elements from backing out of the stack. In this instance, it is also contemplated that the temporary seat or counter-hold element may be designed/adapted to be permanently affixed to/integrated into the space body, whereby in use, the temporary seat or counter-hold element is removed from the MLI panel and affixed to the space body following which the shaft ends of the MLI are once again engaged with the seat or counter-hold elements to secure the MLI to the space body. In the case of those MLI panels wherein the fastening element is a female fastening element designed/adapted to engage a male element on the space body, the method further comprises permanently affixing the female element to the shaft end. To ensure good electrical contact between the fastening elements and the insulation layers, the upper (i.e., outward facing) surface of each insulation layer is or has applied thereto a conductive material, most preferably, a vapor deposited conductive metal.

According to a fourth aspect of the present teaching there is provided a method for affixing an MLI panel comprising a plurality of stacked insulation layers to a space body, said MLI panel having an exterior surface layer which, in use, faces away from the space body to which it is attached, said exterior surface layer having an exterior surface facing away from the space body, and a base layer which, in use, faces the space body to which it is attached, and a plurality of spaced fastening elements, preferably pin elements, most preferably electrically conductive pin elements, generally perpendicular to and extending through the stacked insulation layers and protruding from the base layer, each fastening element having a shaft, a head at one end of the shaft which engages or sits, directly or indirectly, upon the exterior surface of the exterior surface layer, and a shaft end at the other end which i) protrudes from the base layer, the shaft end having a length that is such that when the shaft end engages a space body the MLI panel is spaced from the space body and ii) has a shape or configuration designed/adapted to establish an interference fit or snap fit with the space body or a component or element thereof or affixed thereto, said method comprising I) overlaying the MLI panel over the space body and aligning the shaft ends with a corresponding plurality of seat or counter-hold elements affixed to and/or integrated into the space body and spaced from one another so as to match the spacing of the fastening elements of the MLI panel, the seat or counter-hold elements having an opening or barrel therein capable of and designed/adapted to accept the shaft ends in an interference fit and/or snap fit relationship, II) mating the MLI panel with the space body whereby the shaft ends engage a corresponding seat or counter-hold element and III) forcing the shaft ends into/onto the seat or counter-hold elements to create an interference fit or snap fit hold of the MLI panel on the space body.

Finally, according to a fifth aspect of the present teaching there is provided a space body having one or more MLI panels comprising a plurality of stacked insulation layers fastened thereto by way of an interference fit and/snap fit fastening system, wherein said one or more MLI panels has an exterior surface facing away from the space body, and a base layer facing the space body, a plurality of spaced fastening elements, preferably pin elements, most especially, electrically conductive pin elements, generally perpendicular to and extending through the stacked insulation layers and protruding from the base layer, each fastening element having a shaft, a head at one end of the shaft which engages or sits, directly or indirectly, upon the exterior surface of the exterior surface layer, and a shaft end at the other end which i) protrudes from the base layer and has a length such that the MLI panel is spaced from the space body, and ii) establishes an interference fit and/or snap fit with the space body: most notably elements affixed thereto or integrated therein.

In each of the foregoing embodiments or aspects of the present teaching, it is to be appreciated that the seat or counter-hold elements on or integrated into the space body are electrically conductive whereby when the shaft ends engage the seat or counter-hold elements, an electrical pathway is established allowing electric charge to flow from the MLI to the space body, thereby grounding the MLI panel. Additionally, while it is preferred that the shaft and head of the fastening element, specifically the pin or pin-type element, are inserted into the stack of the insulation layers as a single element with the shaft end being initially inserted through the exterior surface and passing through the stack and protruding beyond the base layer, it is also contemplated that the shaft may initially be inserted through the base layer and the head affixed thereto as it protrudes from the exterior surface, with the shaft end remaining exposed and protruding from the base layer.

As discussed in the Background above, MLI panels are well known and vary in construction and make-up depending upon many factors such as the nature of the space body, the component of the space body to be protected, the environment to which that portion of the space body is to be exposed, etc. The present teaching is applicable to all such MLI panels and further definition thereof is not believed necessary as those skilled in the art will readily appreciate what is meant by an MLI panel. Similarly, the present teaching is applicable to the construction of any type of space body, i.e., a structure meant for placement or travel in space, e.g., space craft, space stations, satellites, etc. Again, the construction of such space bodies is well-known and further discussion is not believed necessary. Furthermore, while many of the fastening systems and/or elements thereof taught for use in accordance with the present teaching are known, their use and/or alignment as contemplated by the present teaching is new. Suitable fastening systems are snap-fit and interference fit fastening systems, most preferably a pin and seat or counter-hold assembly: the seat oftentimes also referred to as a button.

Notwithstanding the foregoing, for added support, a brief reiteration of the elements of the MLI panels is herein provided. As noted, typical MLI panels/blankets are comprised of multiple layers of a thin material with low IR emissivity, preferably lightweight reflective films, and, optionally, though preferably, a durable outer layer. For avoidance of doubt, the base layer, as referenced herein, is an insulating layer and, typically, though most preferably, the exterior layer is also an insulating layer. Preferably, the MLIs comprise multiple layers of metal coated polymer films, metal foils and/or combinations thereof: the latter most preferably being metal coated polymer films and an outermost layer of a metal foil or metal coated polyimide film. Most preferably, MLIs, especially the inner layers thereof, are comprised of polyimide (e.g. Kapton®), polyester (e.g., polyethylene terephthalate (Mylar®) and/or PTFE (e.g. Teflon®) films, preferably polyimide and/or polyester, having laminated thereto or deposited thereon, either painted or by way of vapor deposition, a reflective, preferably highly reflective, metal, most preferably a conductive metal, such as aluminum, gold, silver, germanium, and the like, preferably aluminum and/or gold. These films are extremely thin, from about 4 microns, preferably about 6 microns, up to 200 microns or more, preferably up to 70 microns: generally speaking, though, thinner is better. Notwithstanding the foregoing, the outermost layer is preferably thicker than the underlying layers, perhaps 2 to 3 times the thickness or more, and most are preferably a metal coated Kapton polyimide film: though the innermost layer may also be thicker than the intervening layers. Especially preferred layers are those wherein one or both surfaces are coated by way of vapor deposition with aluminum (high purity aluminum, >95%, preferably, >99%, most preferably 99.99%) on one or both sides: gold, while also extremely suitable is oftentimes considered too costly. These films may be further coated with indium tin oxide, germanium, SiO₂ and other radiation transmissive coatings, especially indium tin oxide, germanium, and/or SiO₂, particularly the exposed exterior layer, to add durability and prevent oxidation.

The MLI structures typically comprise from 3 to 50 or more layers, preferably 5 to 40 layers, more commonly 3 to 30 layers, preferably 10 to 20 layers: the layers being spaced from one another to avoid/minimize thermally conductive contact between adjacent layers and the space body to which it is to be attached, with a density of from about 3 to 30 layers or more per centimeter of thickness; preferably from about 7 to 20 layers per centimeter of thickness. An exemplary MLI comprises 30 layers with a density of 20 layers per centimeter. It is important, if not critical, that the layers be spaced from one another to prevent or minimize thermal conductivity between layers. Such spacing is typically achieved by i) the use of embossing, crimping or dimpling of the low IR emissivity material layers, i.e., the insulation layers, or ii) the placement of thin polymer netting, silk netting, non-woven fiberglass, polyester netting or veil (e.g., Dacron®), tissue paper, and the like, especially nettings or spunbonded or woven materials, which acts as thermal insulation between the layers. Alternatively, newer technology incorporates three-dimensional spacers into and/or between the layers of low IR emissivity material. Additionally, and preferably, the low IR emissivity material layers may be perforated to allow the MLI to vent trapped gas during launch and/or once arriving on-orbit, although this can also be achieved via edge venting. The MLI panels are typically formed by sewing/stitching the layers together and/or the use of plastic fasteners, e.g., polyimide and nylon fasteners, all of which may be used in the practice of the present teachings to form the structured MLI panels; however, the mechanism by which these panels are attached to the space bodies are by use of adhesives and/or hook and loop fasteners and the like, unlike the fastening systems of the present teaching as further discussed below. Exemplary MLIs are disclosed in, for example, Marzi et. al., (U.S. Pat. No. 5,111,354), Dye et. al. (U.S. Pat. Nos. 8,234,835 B2, 10,753,527 B1), Hasegawa et. al. (US 2003/0082332 A1), Okamoto et. al. (U.S. Pat. No. 5,531,957), Fellas (U.S. Pat. No. 4,489,906), and Charvet (EP 2530366 A1), the contents of which are hereby incorporated herein by reference.

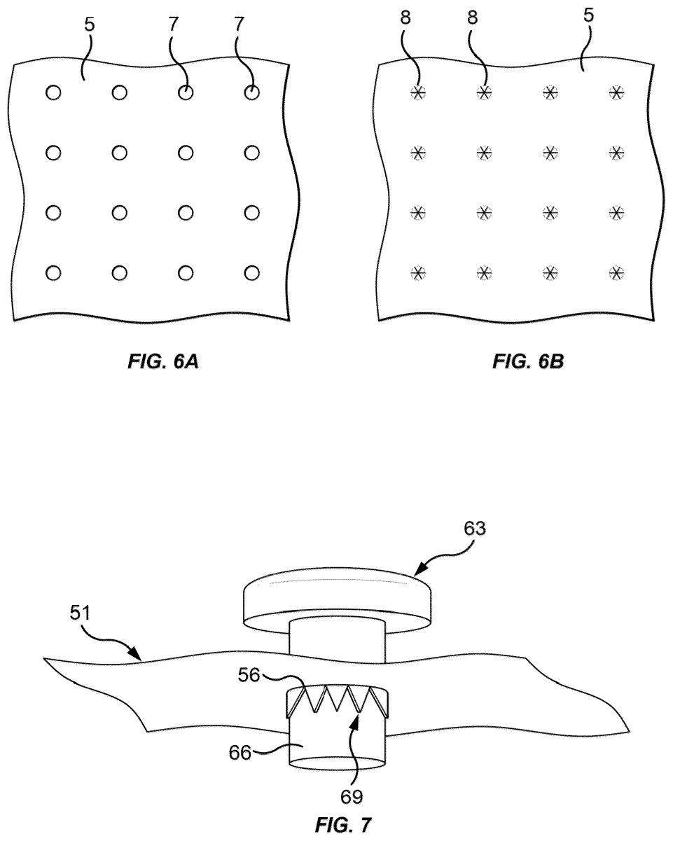

While fasteners and fastening systems as presented herein are applicable to MLIs generally, there are certain aspects of MLI construction and design that are especially beneficial to the present teachings. Similarly, while certain of the fasteners suitable for use in the practice of the present teaching have been used in MLI production, others have not, and those that have, have not been used as contemplated by the present teaching and, in following, the art has not benefited from these applications. For example, as shown in FIGS. 6A and 6B, the layers of the MLI panel 5 will preferably have spaced, preformed holes 7 or star or cross slits/cuts 8 through them so as to provide a path for the fastening elements, namely the pins, to pass through with relative ease. In the case of MLI layers with the holes, as depicted in FIGS. 13 and 14, the layers 50 of the MLI panel typically comprise a polymer film 52 with a conductive coating 54 applied to one or both surfaces thereof. To ensure a good conductive path between the MLI layers and the pin, the conductive coating also covers the inner surface of the through holes 65. In following, the selection of the pin elements for use with these panels is such that the diameter of the pin is the same as or slightly larger than the diameter of the through hole whereby there is conductive contact or a slight interference between the pin and the wall of the holes when assembled. In the case of MLI panels having the star or cross slits/cuts, as shown in FIGS. 15 and 16, the conductive coating 54 only need be present on the surface(s) of the polymer film 52 and does not need to penetrate into the slit 56. Rather, in this instance, as shown in FIG. 7, as the pin fastener 60 penetrates the star slit 56 of the MLI layer 51, contact is made between the surface of the fins 62 and the surface of the pin shaft 61. Where the MLI layer 51 only has the conductive coating on one surface thereof, the pin is first penetrated through that surface to ensure conductive contact between the fin surface and the pin shaft.

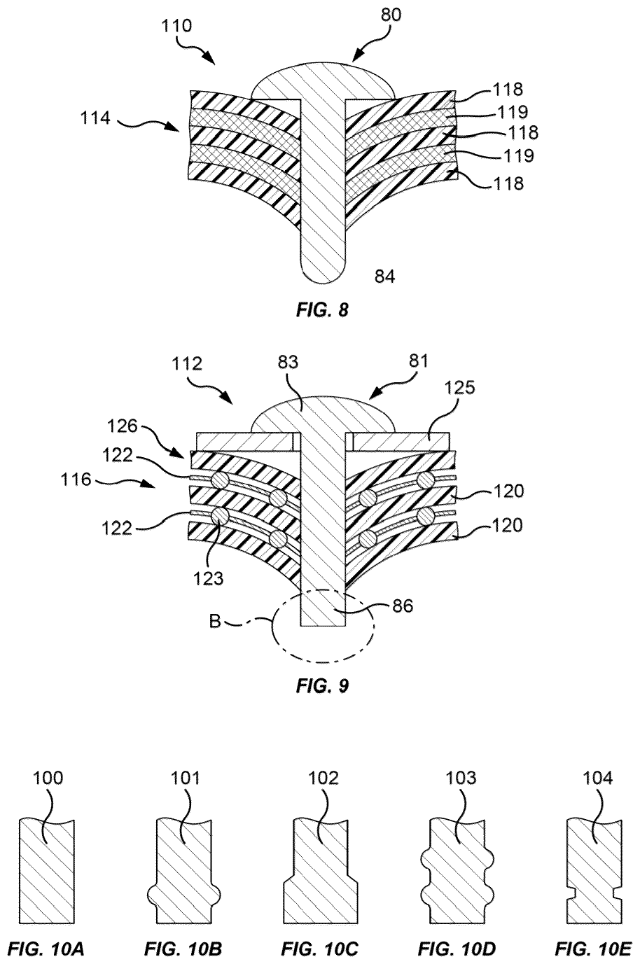

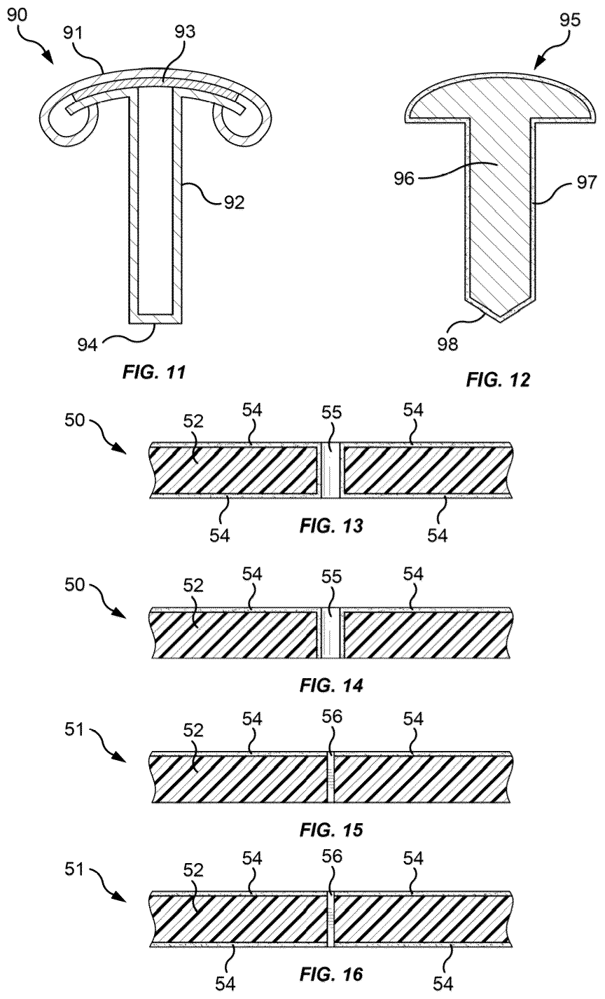

Suitable pin elements are likewise well known and some variants are already employed in MLI panel construction, but in different ways and, more specifically, for a different purpose than in the present teaching. Pin elements may be solid, as shown as element 80 and 81 in FIGS. 8 and 9, respectively, or hollow as shown as element 90 in FIG. 11, coated solid or hollow elements, the former as shown in FIG. 12. If the pin is made of an electrically non-conductive material, whether solid or hollow, or even if made of an electrically conductive material, it may also have applied thereto a coating, especially an electrically conductive coating. For example, FIG. 11 shows a hollow pin 90 made of formed metal sheets, one forming the head 91, another the shaft portion 92 and a third 93 inserted to add reinforcement to the head and pin overall. These pins may be coated or plated with a metal as shown in Mil Spec 27980, which is incorporated herein by reference. FIG. 12 embodies a solid pin 95 whose body 96 is coated or plated with a metal or protective coating 97. Preferably, the pins are formed of thermally non-conductive or poorly conductive materials, e.g., polyetherimide, composite, nylon, etc. In the case of thermally conductive materials, it is best that the thermal conductivity be low or minimal and/or that the pins be hollow: again, to minimize thermal conductivity. In any event, two critical elements for the pin-type elements employed for fastening the MLI to a space body in accordance with the present teaching is that the length of the shaft of the pin element is sufficiently long so that it extends through and protrudes beyond the innermost layer of the MLI, i.e., the base layer, and is electrically conductive or incorporates a surface coating or plating that is electrically conductive. Most preferably, the length of the shaft is such that the MLI panels, once attached to the space body, are raised/separated from the space body. Typically, this is a matter of millimeters or a centimeter or two at most.

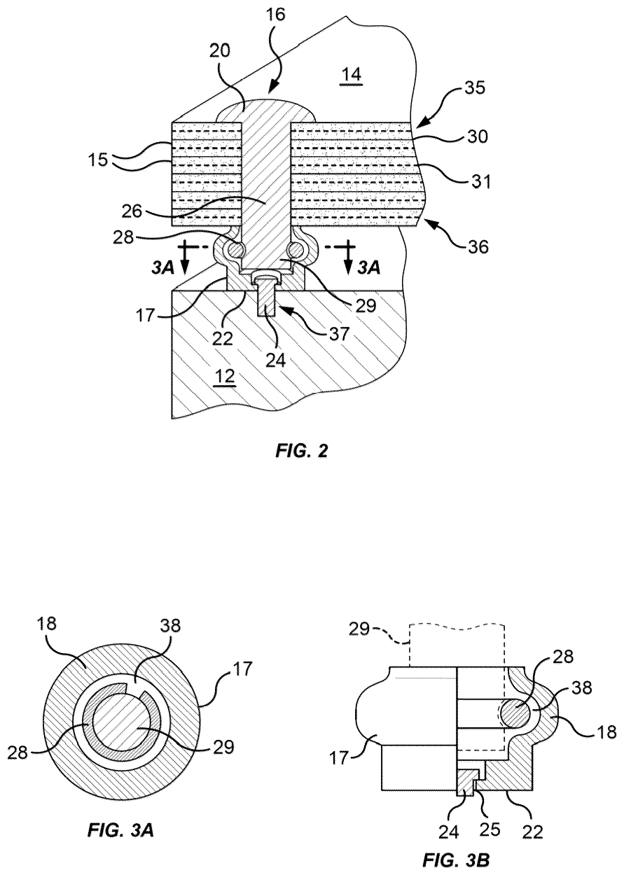

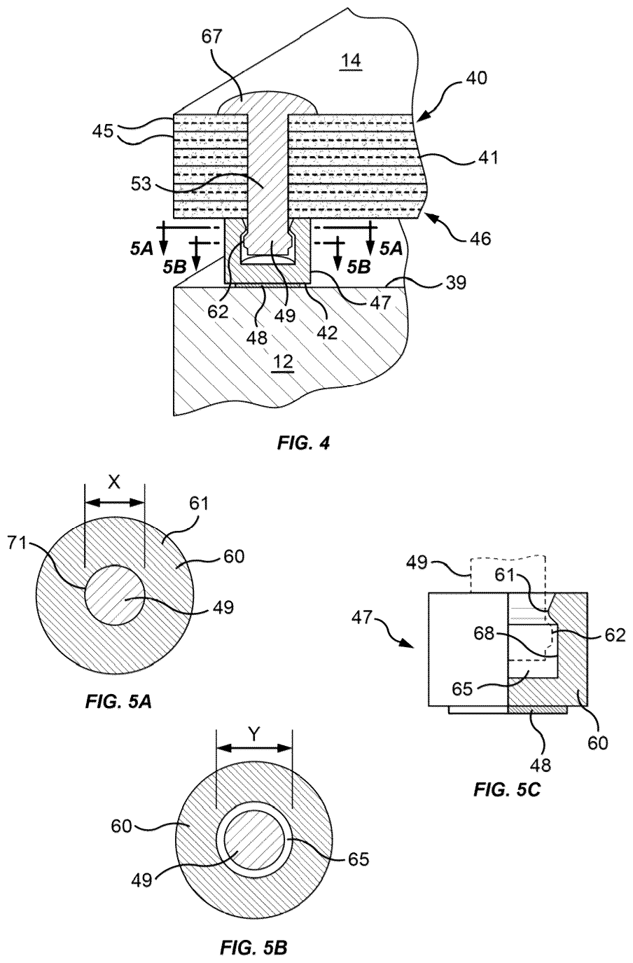

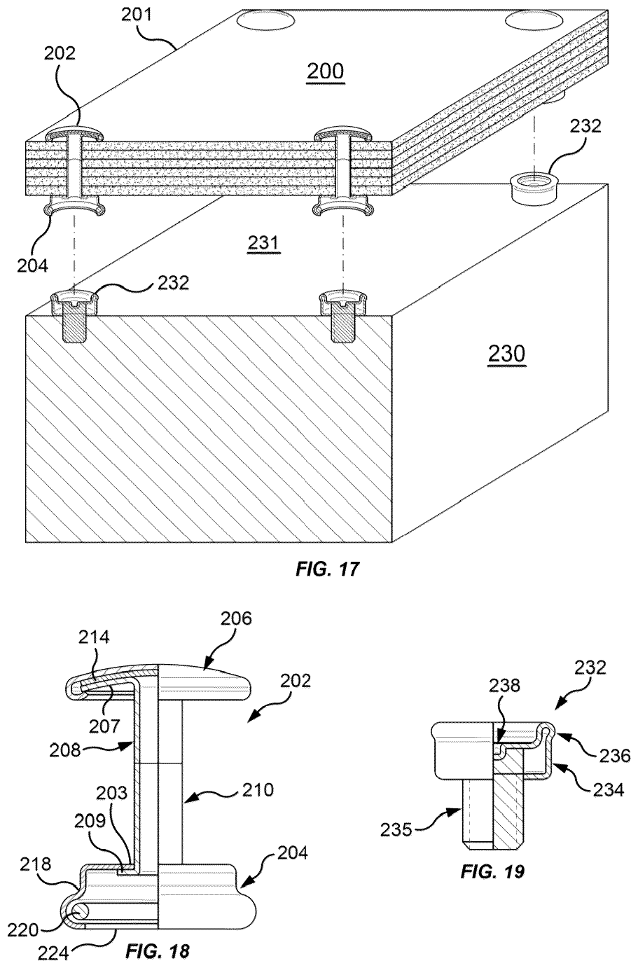

The shaft end may end with a flat surface 94 as shown in FIG. 11, a rounded or hemispherical surface 84 as shown in FIG. 8, a pointed surface 98 as shown in FIG. 12, or the like. In the case of the flat surface, a solid pin will have a solid flat surface, whereas a hollow pin would have an open flat surface whose cross-section is a ring. The presence of a rounded or a pointed surface helps with the alignment and penetration of the pin with and through, respectively, the MLI layers. Again, depending upon whether the pin is solid or hollow, the end may be solid or have an opening, essentially resembling a conically shaped orifice. Alliteratively, as discussed with respect to FIGS. 17 and 18 below, the shaft end may integrate a separate element, a male or female fastening/joining element, preferably one that has a greater diameter than the shaft itself. Additionally, the shaft ends may take different shapes and have differing/changing cross-sections depending upon the nature of the seat or counter-hold element and the intended interference fit/snap fit. In this respect FIGS. 10A-10E present different embodiments of the shaft end 86 for pin 81 in FIG. 9, the shaft end being that portion encircled by dotted circle B. Each of these embodiments would be used with various seats or counter-hold elements as follows:
FIG. 10A shows a shaft end 100 with a constant diameter. This pin type would be used with a seat or counter-hold with a cylindrical bore of slightly less diameter than the diameter of the shaft end so as to create a strong interference fit or with a spring clip type seat as shown in FIGS. 2, 3A and 3B, discussed in greater detail below.
FIGS. 10B thru 10D show shaft ends 101 thru 103, respectively, with different configurations of one or more circumferential expansions. This pin type would be used with a seat or counter-hold having a restricted portion that the end of the pin shaft, i.e., the shaft end, passes through and into and whose diameter is slightly less than the diameter of the expansion of the pin shaft end. Such an embodiment is shown more clearly in FIGS. 4 and 5A thru 5C, discussed in greater detail below.
FIG. 10E shows a shaft end 104 with a circumferential recess. Although this pin type could would be used with a seat or counter-hold having a restricted portion whose expansion engages the recess, it is preferably used with a seat or counter-hold having a spring clip which, upon mating, sits in the recess.

Depending upon the need for and/or desirability of the MLI panel being removed from the space body once applied/affixed thereto, the circumferential expansions and recesses on the shaft ends and/or the circumferential expansions on the inner walls of the bore or barrel of the seats or counter-hold elements may be sloped, as more clearly shown in, e.g., FIG. 5C, to allow for the removal of pin element from the seat/counter-hold element.

Finally, depending upon the site of use of the given MLI panel, it is important to ensure that consideration is given to the need to address the coefficient of expansion of the pin and seat or counter-hold elements. Specifically, especially for those elements that rely upon an interference fit, it is important that the interference fit not be lost due to a difference in the coefficient of thermal expansion between the pin element and the body of the seat or counter-hold in which the bore or barrel is present. Obviously, this may be addressed by using the same materials for both elements or materials that have the same or similar coefficients of thermal expansion.

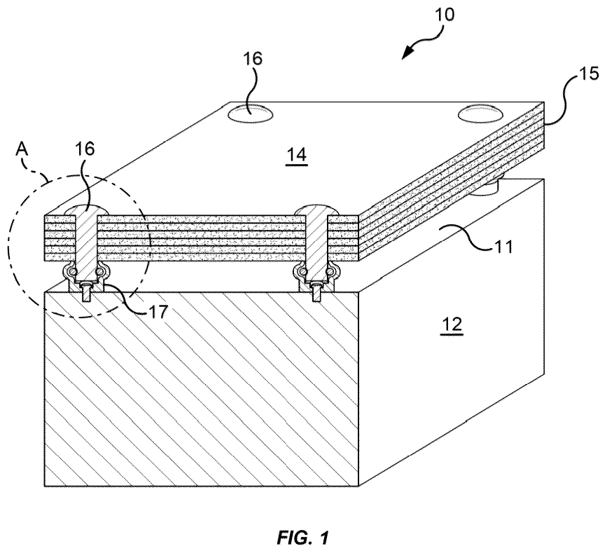

Turning to the embodiments of the present teaching, FIG. 1 depicts a segment of a space body 12 having affixed thereto an MLI panel 14 comprising a plurality of insulation layers 15 which MLI panel is affixed to the space body by a plurality of spaced pin fastening elements 16 which penetrate through the layers of the MLI and engage a seat or counter-hold 17 which is attached to the surface 11 of the space body. FIG. 2 provides a closer view of that portion of the space body denoted by the dotted circle A in FIG. 1. Here it is seen that the pin fastening element comprises an elongated shaft portion 26, a head portion 20 and a shaft end 29. The pin fastening element penetrates the MLI in a contact or slight interference fit relationship from the upper surface 35 of the MLI panel, and each successive layer, to and through the bottom layer 36 of the MLI panel and engages the seat or counter-hold element 17. The counter-hold element is fastened to the surface of the space body 12 by a screw 24 which passes through and engages the base 22 of the counter-hold element and engages a bore 37 in the surface of the space body.

FIGS. 3A and 3B provide views of the seat or counter-hold element 17: the former a top-down view of the cross-section of the seat or counter-hold element of FIG. 2 taken along line 1-1 of FIG. 2. As indicated, the body 18 of the seat or counter-hold element 17 has a bore or chamber 38 in which lies a snap-ring or spring clip 28 which grasps the shaft end 29 (shown in dotted lines in FIG. 3B) of the pin element 26 in a snap-fit type relationship. The base 24 of the body 18 has a hole 25 through which the screw 24 passes to fasten the seat or counter-hold element to the space body.

In this embodiment, the body 18 of the seat or counter-hold element 17 is in conductive contact, directly or indirectly, with the shaft end 29 and/or the bottom layer 36 of the MLI panel and the base 22 of the seat or counter-hold element 17 is in conductive contact with the surface of the space body 12. Conductive contact may also be made through the screw 24 securing the seat or counter-hold element 17 to the space body.

FIG. 4 shows an alternate embodiment to that shown in FIG. 2 wherein a different snap-fit mechanism is employed. Specifically, FIG. 4 depicts a segment of a space body 12 having affixed thereto an MLI panel 14 comprising a plurality of insulation layers 45 which MLI panel is affixed to the space body by a plurality of spaced pin fastening elements 43 which, as in the prior embodiment, penetrate through the layers of the MLI with a conductive contact and engage a seat or counter-hold 47 which is attached to the surface 39 of the space body by a tack weld or conductive adhesive 48. Here the pin fastening element 43 comprises an elongated shaft portion 46, a head portion 67 and a shaft end 49, the shaft end incorporating a circumferential expansion or flange portion 62 making the diameter of the pin at that point larger than the remainder of the shaft. As with the prior embodiment, the pin fastening element penetrates the MLI in a contact or slight interference fit relationship from the upper surface 40 of the MLI panel to and through the bottom layer 46 of the MLI panel and engages the seat or counter-hold element 47. The seat or counter-hold element 47 has a bore or chamber 65 integrated therein whose sidewall 68 includes a circumferential expansion or flange 61 which creates a restriction for the shaft end as it enters the bore of the seat or counter-hold element.

As shown more clearly in FIGS. 5A and 5B, which provide cross-sectional views of the seat or counter-hold element 47 of FIG. 4 at lines 2-2 and 3-3, respectively, and FIG. SC which shows the seat or counter-hold element with the front upper quadrant removed, the snap-fit mechanism of this fastening system works by way of an interlocking effect created by the expansion or flange 61 protruding from the surface of the chamber 65 and the circumferential expansion or flange 62 protruding from the surface of the shaft end 49 once the latter passes through the former. Comparing the cross-sections of FIG. 5A with 5B, it is clear that the diameter “x” of the bore or chamber in the seat or counter-hold body at the point of the flange 61, i.e., along line 2-2, is smaller than the diameter of the chamber as a whole as shown at line 3-3. In the former, as shown in FIG. 5A, the end shaft is of the same or close to the same diameter as the passageway through the constriction 71, most preferably it is of the same or has a slight interference fit to ensure conductive pathway from the pin element to the seat or counter-hold element. In the latter, as shown in FIG. 5B, there is a gap or space between the sidewall of the shaft end (the shaft end in FIG. 5C being shown in dotted lines) and the sidewall 68 of the bore 65 of the body 60.

As with the prior embodiment, in this embodiment, the body 60 of the seat or counter-hold element 47 is in conductive contact, directly or indirectly, with the shaft end 49 and/or the bottom layer 46 of the MLI panel and the base 42 of the seat or counter-hold element 47 is in conductive contact with the surface of the space body 12, most preferably through a spot weld or the use of a conductive adhesive.

FIGS, 8 and 9 depict close-up views of MLI panel/pin assemblies 110, 112 wherein the pins 80,81 have a significant interference fit with a preformed hole or with a star/slit in the MLI panels 114,116. In FIG. 8, there are multiple layers of the polymer film 118 separated by a layer of thermal insulation 119, preferably a netting. In FIG. 9, the multiple layers of the polymer film 120 are separated by a sheet 122 having a plurality of spaced spacer elements 123. Additionally, in this embodiment, a washer 125 is employed to prevent the head 83 of the pin 81 from passing into or through the upper layer 126 of the MLI panel. Though not shown, instead of or in addition to a washer, one may use an MLI panel whose upper layer is formed of a more rigid material and/or is thicker whereby it does not deflect as much or has a simple contact/interference fit as shown with respect to upper layer 35 in FIG. 2.

While the foregoing discussion has been, for the most, premised upon the pin element in the MLI layer as being a male fastener element and the seat on the body, especially the space body, being the female receptor element, it is also contemplated that the roles of the elements may be reversed. Specifically, FIG. 17 depicts the mating of a segment of an MLI panel 200 to a segment of a space body 230 wherein the MLI 201 has integrated therein a plurality of spaced female fastener elements 202, more clearly shown in FIG. 18, and the space body has a corresponding plurality of correspondingly placed male stud or post elements 232, as shown more clearly in FIG. 19, fastened to the surface 231 of the space body.

As shown in FIG. 18, the female fastener element 202 comprises a button portion 206, a stem portion 210 and a seat or receptacle 204. In this particular embodiment, all of the body elements of the female fastener element are formed of a metal sheet material, preferably a conductive metal sheet material or a metal sheet material having a conductive metal coating, whereby the elements are essentially hollow. The stem portion 210 has three sections, the elongated stem body 208, a top flange 207 which is integrated by a crimp into the cap 206 and a lower flange 209 which is integrated into the seat or receptacle 204 by a crimping or swaging process following the insertion and penetration of the stem through the layers of the MLI and into the seat or receptacle. Optionally, though shown, the button may also incorporate a reinforcing sheet 214 to add strength to the button and the overall fastener element. The seat or receptacle 204 has an opening 203 in its upper surface to allow for the end portion of the stem body to pass through at which point the end of the stem is subjected to crimping or swaging whereby the receptacle 204 is mechanically locked onto the end of the stem. The seat or receptacle 204 also has a shaped or contoured body 218 which includes a recess in which a spring ring-type locking element 220 is retained.

As shown in FIG. 19, the male stud or post element 232 comprises two main elements, a post body 234 and a threaded stem 235. The post body includes an internal recess 238 which allows one to screw the male stud or post element to the space body as well as an expanded upper rim expansion 236 whereby the diameter of the expanded rim is greater than the diameter of the lower portion of the post body.

In this embodiment, the male and female elements are properly sized whereby the diameter of the opening 224 of the receptacle 204 is greater than the outer diameter of the expanded rim 236 of the post body 234 to allow the latter to pass through the former. On the other hand, the inner diameter of the spring ring-type locking element, in its normal state, is smaller than the outer diameter of the expanded ring, whereby as the two fastening elements are mated to one another, the expanded rim 236 engages inner surface of the spring ring-type locking element 220, which, upon pressing of the female element against the male element, causes the spring ring-type locking element to open and increases its circumference to allow the expanded rim to pass therethrough. Once the expanded rim passes through the spring ring-type locking element, the spring contracts so as to create a snap-fit mating whereby the male post or stud element is securely, yet releasably, held by the seat or receptacle of the female fastening element.

Of course, alternatively, the male and female locking elements of this embodiment may be reversed whereby the stud or post element is crimped or swaged onto the end of the stem of the pin in the MLI panel and the seat or receptacle containing the spring ring-type locking element is integrated into or affixed to the surface of the space body. Specifically, in this instance, the fastener element on the space body would be the female element and comprise the body 204 of the seat or receptacle and the threaded element 235 and the fastener element integrated into the MLI, the male portion, would comprise the button 206, the stem 210 and, swaged thereto, the stud or post element.

The benefits of the MLI panels of FIG. 17 and of the preceding paragraph are multifold as these embodiments allow for the stock production of MLI panels that are readily attachable to a space body without the need to separately sew or interconnect the layers of the MLI and subsequently integrate fastening means since the fastener element in these instances serves as both the means for securing the layers of the MLI to one another and the means for securely attaching the MLI to a space body. Here multiple MLI panels may be produced, handled and stored without concern that the pin elements will pull out of the MLI panes and/or one or more of the layers of the MLI slip off the end of the pin. Indeed, as noted above, these MLI panels are themselves a subject of the present invention and claims.

Although the articles and method of the present teaching have been described with respect to specific embodiments and figures, it should be appreciated that the present teachings are not limited thereto and other embodiments utilizing the concepts expressed herein are intended and contemplated without departing from the scope of the present teaching. Specifically, it is to be appreciated that the present teaching is applicable to all iterations of MLIs employing the various components and combinations thereof as discussed generally in the background section above. Thus, the true scope of the present teachings is defined by the claimed elements and any and all modifications, variations, or equivalents that fall within the spirit and scope of the underlying principles set forth herein.

I claim:

1. An MLI panel for attachment to a space body, the MLI panel comprising a plurality of stacked insulation layers, said MLI panel having an exterior surface layer which, in use, faces away from the space body to which it is attached, said exterior surface layer having an exterior surface facing away from the space body, and a base layer which, in use, faces the space body to which it is attached, and a plurality of spaced fastening elements generally perpendicular to and extending through the stacked insulation layers and protruding from the base layer, each fastening element having a shaft, a head at one end of the shaft which engages or sits, directly or indirectly, upon the exterior surface of the exterior surface layer, and a shaft end at the other end which i) protrudes from the base layer, the shaft end having a length that is such that when the shaft end engages a space body the MLI panel is spaced from the space body and ii) has a shape or configuration designed/adapted to establish an interference fit or snap fit with the space body or a component or element thereof or attached thereto.

2. The MLI panel of claim 1 wherein a) the stacked insulation layers are or include at least one surface that is electrically conductive, b) the fastening elements or the surface thereof are electrically conductive, and c) the stacked insulation layers and the fastening elements are in electrical conducting contact with each other.

3. The MLI panel of claim 2 wherein the stacked insulation layers have through holes, slits or star-shaped perforations through which the fastening elements pass.

4. The MLI panel of claim 3 where the fastening element has been inserted through stacked insulation layers beginning with the exterior surface layer.

5. The MLI panel of claim 1 wherein the MLI panel further comprises removeable seat or counter-hold elements having an opening or barrel therein or a stud or stud-like element thereon capable of and designed/adapted to accept the shaft end of the pin-type element in an interference fit and/or a snap fit arrangement.

6. The MLI panel of claim 5 wherein the removeable seat or counter-hold elements are designed/adapted to be affixed to/integrated into the space body

7. The MLI panel of claim 2 wherein the MLI panel further comprises removeable seat or counter-hold elements having an opening or barrel therein capable of and designed/adapted to accept the shaft end of the pin-type element in an interference fit and/or a snap fit arrangement.

8. The MLI panel of claim 7 wherein the removeable seat or counter-hold elements are electrically conductive and are designed/adapted to be affixed to/integrated into the space body whereby when the MLI is affixed to a space body, the MLI is grounded by the space body through the fastening elements.

9. The MLI panel of claim 1 wherein the shaft end has a shape or configuration designed/adapted to establish a snap fit with the space body or a component or element thereof or attached thereto.

10. A method for producing an MLI panel comprising a plurality of stacked insulation layers, the stacked insulation layers comprising a) an exterior surface layer which, in use, faces away from the space body to which the MLI panel is to be attached, said exterior surface layer having an exterior surface facing away from the remainder of the stacked insulation layers, b) a base layer which, in use, faces the space body to which it is to be attached, and c) a plurality of insulation layers intermediate the two, said stack of insulation layers being held together by a plurality of spaced fastening elements generally perpendicular to and extending through the stacked insulation layers and protruding from the base layer, each fastening element having an elongated shaft whose length is longer than the height of the stacked insulation layers, a head at one end of the shaft and a shaft end at the other end which method comprises i) creating the stack of insulation layers, each layer thereof having a plurality of spaced holes, slits and/or star shaped perforations, each aligned over the spaced holes, slits and/or star shaped perforations of the other layers, ii) inserting the fastening elements into the spaced holes, slits and/or star shaped perforations of the exterior surface layer and iii) continuing to press the fastening elements into the spaced holes, slits and/or star shaped perforations until the head of the fastening elements contacts, directly or indirectly, the exterior surface of the exterior surface layer and the shaft end protrudes from the base layer, said shaft end including or after insertion being modified to have a configuration or design adapted to establish an interference fit or snap fit with the space body or a component or element thereof or attached thereto.

11. The method of claim 10 further comprise affixing a temporary seat or counter-hold element to the shaft ends each temporary seat or counter-hold element having an opening or barrel therein or a stud or stud-like element thereon capable of and designed/adapted to accept the shaft ends in an interference fit and/or snap fit relationship.

12. The method of claim 10 wherein the end shaft of the fastener is first passed through a washer before being inserted through the exterior surface layer.

13. The method of claim 10 wherein the fastener elements and/or the surface thereof are electrically conductive.

14. The method of claim 10 wherein a) the stacked insulation layers are or include at least one surface that is electrically conductive, b) the fastening elements and/or the surface thereof are electrically conductive, and c) the fastener elements establish electrical contact with the insulation layers as they are inserted into and through the stack of insulation layers.

15. The method of claim 10 wherein the shaft end has a shape or configuration designed/adapted to establish a snap fit with the space body or a component or element thereof or attached thereto.

16. A space body have one or more MLI panels attached thereto said one or more MLI panels comprising a plurality of stacked insulation layers, and having an exterior surface layer facing away from the space body to which it is attached, a base layer adjacent to and facing the space body to which it is attached, a plurality of insulation layers intermediate the exterior surface layer and the base layer, and a plurality of spaced fastening elements generally perpendicular to and extending through the stacked insulation layers and protruding from the base layer, each fastening element having a shaft, a head at one end of the shaft which engages or sits, directly or indirectly, upon the exterior surface of the exterior surface layer, and a shaft end at the other end which i) protrudes from the base layer and engages the space body or a component or element thereof with an interference fit or snap fit.

17. The space body of claim 16 wherein a) the stacked insulation layers are or include at least one surface that is electrically conductive, b) the fastening elements and/or the surface thereof are electrically conductive, and c) the fastener elements establish electrical contact with the insulation layers.

18. The space body of claim 17 wherein the fastener element establishes electrical contact with the space body or the component or element thereof with which it is engaged.

19. The space body of claim 16 wherein the shaft end has a shape or configuration designed/adapted to establish a snap fit with the space body or a component or element thereof or attached thereto.

20. The space body of claim 16 wherein the shaft end protrudes from the base layer a length corresponding to the desired gap or spacing between the MLI and the space body.
